(19) United States
(12) Patent Application Publication
(10) Pub. No.: US 2026/0238287 A1
(43) Pub. Date: Aug. 13, 2026

(54) REFERENCE SIGNAL CONFIGURATION FOR TIME-DOMAIN CHANNEL PROPERTY EVALUATION

(71) Applicant: MEDIATEK INC., Hsinchu City (TW)

(72) Inventors: Yahia Ahmed Mahmoud Mahmoud SHABARA, San Jose, CA (US); Parisa CHERAGHI, San Jose, CA (US)

(21) Appl. No.: 19/164,281

(22) PCT Filed: Mar. 21, 2024
(86) PCT No.: PCT/CN2024/082944

§ 371 Date: Sep. 11, 2025

Related U.S. Application Data
(60) Provisional application No. 63/491,323, filed on Mar. 21, 2023.

(51) Int. Cl. H04B 7/06; H04L 5/00

(52) U.S. Cl. CPC H04B 7/0626; H04L 5/0048

(57) ABSTRACT

Techniques for improving reference signal configuration for time-domain channel property evaluation are described. A user equipment (UE) receives a tracking reference signal (TRS) burst from a network node that includes only a single channel state information reference signal (CSIRS) resource-containing time slot per each TRS period of the TRS burst, in which each single time slot comprises one or more CSIRS resources. The UE then calculates one or more channel state information (CSI) parameters based at least on the TRS burst.

### CROSS REFERENCE TO RELATED PATENT APPLICATION(S)

The present disclosure is part of a non-provisional application claiming the priority benefit of U.S. Patent Application No. 63/491,323, filed 21 Mar. 2023, the content of which herein being incorporated by reference in its entirety.

### TECHNICAL FIELD

The present disclosure is generally related to wireless communications and, more particularly, to reference signal configuration for time domain channel property (TDCP) calculation.

### BACKGROUND

Unless otherwise indicated herein, approaches described in this section are not prior art to the claims listed below and are not admitted as prior art by inclusion in this section. Time domain channel property (TDCP) is a new channel state information (CSI) feedback metric that is introduced in Release 18 of 5GNR. TDCP is provided by user equipment (UE) to a network node, e.g., a gNodeB (gNB) of a wireless carrier network to provide the network node with information regarding time behavior for a channel. TDCP is calculated at the UE based on tracking reference signals (TRS) for feedback to a network node, in which TRS are downlink signals used by the UE in legacy 5GNR to track time and frequency fluctuations. Accordingly, TDCP is a new application of TRS-based channel estimation.

Under Release 18 of 5GNR, TDCP may be used by a network node to aid the implementation of CSI prediction in time division duplex (TDD) systems. Furthermore, TDCP can also be used by the network node to configure related parameters, such as the determination of an optimal downlink codebook, e.g., Type I or Rel-16 Type II, and the determination of a sounding reference signal (SRS) periodicity. TDCP under Release 18 is based on channel auto-correlation. The basic feature of TDCP is to feedback an auto-correlation coefficient to a network node. The UE may also optionally feedback multiple auto-correlation coefficients that enable a network node to calculate a doppler spectrum.

However, although TDCP may be calculated based on TRS, the currently allowed signal configurations of TRS are not readily suitable for TDCP measurements. For instance, the smallest time period for periodic TRS is 10 milliseconds, which can be too large for TDCP calculation and may introduce aliasing in the doppler spectrum. Additionally, the currently allowed signal configurations of TRS have high density per burst. Specifically, each existing or legacy TRS resource set may have up to four channel state information reference signal (CSIRS) resources divided across two time slots (e.g., two CSIRS resources per slot). Such high-density resource element (RE) allocation may not be needed for TDCP calculations. Furthermore, the CSIRS resources per each TRS resource set are not uniformly allocated across orthogonal frequency division multiplexing (OFDM) symbols, which may lead to the waste of resources during TDCP calculations.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for improving reference signal configuration for time-domain channel property evaluation.

In one aspect, a method may include receiving, by a processor of a UE, a TRS burst from a network node that includes only a single CSIRS resource-containing time slot per each TRS period of the TRS burst, in which each single CSIRS resource-containing time slot comprises one or more CSIRS resources. The method further includes calculating, by the processor, one or more CSI parameters based at least on the TRS burst.

In another aspect, a method may include receiving, by a processor of a UE, a TRS group that includes multiple TRS bursts from a network node. The method further includes calculating, by the processor, one or more CSI parameters based at least on one or more TRS bursts of the multiple TRS bursts included in the TRS group.

In yet another aspect, an apparatus may include a transceiver configured to communicate wirelessly and a processor coupled to the transceiver. The processor may receive a CSIRS resource set that includes multiple NZP CSIRS resources that are not part of a TRS burst. The processor may further calculate a TDCP based on the CSIRS resource set.

It is noteworthy that, although description provided herein may be in the context of certain radio access technologies, networks, and network topologies for wireless communication, such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 illustrates example time lags associated with TRS bursts in accordance with the present disclosure.

FIG. 3 illustrates example configurations of multiple TRS bursts in accordance with the present disclosure.

FIG. 4 illustrates an example spacing of CSIRS resources in two time slots in accordance with the present disclosure.

FIG. 5 shows example implementations of TRS that use one-slot TRS configurations alternatively or in combination with two-slot TRS configurations.

FIG. 6 illustrates example TRS configurations in accordance with the present disclosure.

FIG. 7 illustrates an example TRS configuration that includes defining a TRS group that includes multiple TRS bursts.

FIG. 8 illustrates the various TRS configuration parameters that may be applied in a TRS configuration in accordance with an implementation of the present disclosure.

FIG. 9 illustrates a first combination of an example legacy TRS configuration with an example new TRS configuration in accordance with the present disclosure.

FIG. 10 illustrates a second combination of an example legacy TRS configuration with an example new TRS configuration in accordance with the present disclosure.

FIG. 11 illustrates an example configuration of non-TRS CSIRS resources for the calculation of TCDP in accordance with the present disclosure.

FIG. 12 is a block diagram of an example communication system in accordance with an implementation of the present disclosure.

FIG. 13 is a flowchart of a first example process in accordance with an implementation of the present disclosure.

FIG. 14 is a flowchart of a second example process in accordance with an implementation of the present disclosure.

FIG. 15 is a flowchart of a third example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions for improving reference signal configuration for time-domain channel properties evaluation. According to the present disclosure, a number of possible solutions may be implemented separately or jointly. That is, although these possible solutions may be described below separately, two or more of these possible solutions may be implemented in one combination or another.

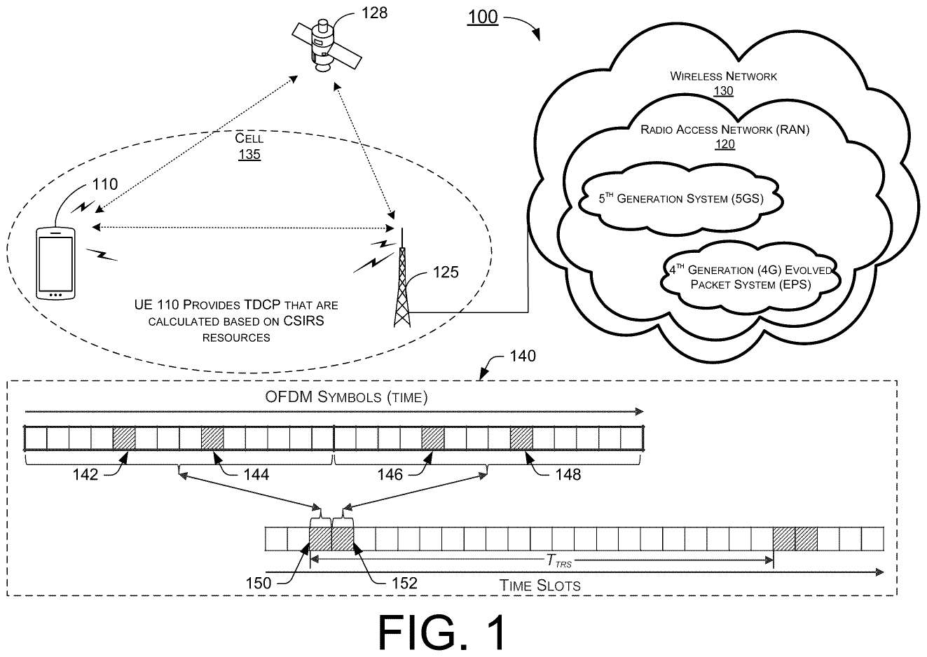

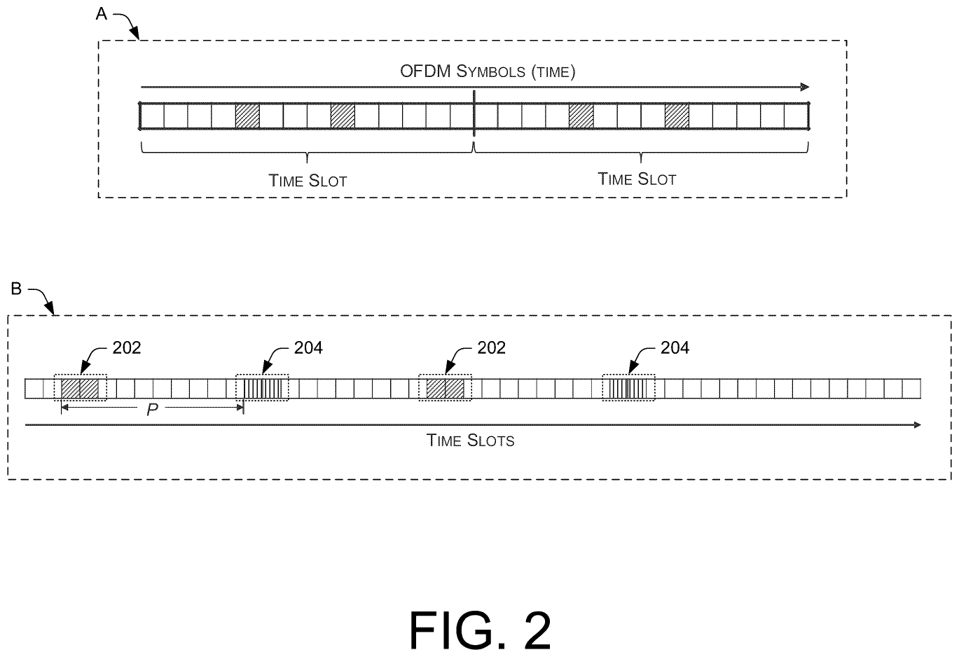

FIG. 1 illustrates an example network environment 100 in which various solutions and schemes in accordance with the present disclosure may be implemented. FIG. 2-FIG. 15 illustrate examples of implementation of various proposed schemes in network environment 100 in accordance with the present disclosure. The following description of various proposed schemes is provided with reference to FIG. 1-FIG. 15.

Referring to FIG. 1, network environment 100 may include a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB, or transmit-receive point (TRP)) and/or a non-terrestrial network node 128 (e.g., a satellite). That is, UE 110 may be within coverage of a cell 135 associated with terrestrial network node 125 or non-terrestrial network node 128. RAN 120 may be a part of a network 130. In network environment 100, UE 110 and network 130 (via terrestrial network node 125 or non-terrestrial network node 128 of RAN 120) may implement various schemes pertaining to improvement of reference signal configuration for time-domain channel property evaluation as described below. It is noteworthy that, although various proposed schemes, options, and approaches may be described individually below, in actual applications these proposed schemes, options, and approaches may be implemented separately or jointly. That is, in some cases, each of one or more of the proposed schemes, options, techniques, and approaches may be implemented individually or separately. In other cases, some or all of the proposed schemes, options, techniques, and approaches may be implemented jointly.

Under various proposed schemes in accordance with the present disclosure, a UE, such as the UE 110, may provide TDCP to a network node, e.g., network node 125, that are calculated based on CSIRS resources, such as CSIRS resources of TRSs. In turn, the TDCP may be used by the network node to implement CSI predictions for TDD systems, determine optimal downlink codebooks, determine SRS periodicities, and/or so forth. As shown in FIG. 1, an example legacy TRS resource set 140 of a periodic TRS burst in frequency range (FR) 1 may have up to four CSIRS resources, e.g., CSIRS resources 142, 144, 146, and 148 that are divided across two time slots 150 and 152. Further, as further shown in FIG. 1, the CSIRS resources 142, 144, 146, and 148 may not be uniformly allocated across OFDM symbols in the time slots 150 and 152. It will be appreciated that FR 1 refers to frequency bands of sub-6 GHz frequencies, such that the various TRS and the CSIRS resources described in the context of the current disclosure may be in FR1.

Thus, improvements in the configuration of TRS may in turn improve the ability of UEs (e.g., UE 110) to timely calculate TDCP feedback metrics for network nodes (e.g., network node 125) that enhance the ability of the network nodes to perform their tasks, while in some cases also reduce the amount of TRS overhead. In addition, the TDCP metrics in Release 18 5GNR may be auto-correlation (AC) coefficients for a channel. Accordingly, the network node 125 may calculate a doppler spectrum and/or a delay spread based on a quantized version of the AC that is received from the UE 110.

The time lags at which the AC and other TDCP-based parameters are calculated by UE 110 may be controlled by the network node 125, which selects an appropriate TRS configuration to enable the TDCP calculations by a UE. For example, for a periodic TRS burst (resource set) shown in Part A of FIG. 2 that repeats over multiple time slots, the time lags of the TRS burst may be 0, 4T_{OFDM}, N_{OFDM}T_{OFDM} and (N_{OFDM}+4) T_{OFDM}, in which T_{OFDM} is the OFDM symbol time duration in seconds and N_{OFDM} is the number of OFDM symbols per time slot. In another example, the network node 125 may configure multiple TRS bursts as shown in Part B of FIG. 2, in which 202 represents a first TRS burst, and 204 represents a second TRS burst. This configuration as shown in Part B assumes the use of a two-slot TRS configuration for each TRS burst. A two-slot TRS configuration is a configuration in which there are two consecutive CSIRS resource-containing time slots per corresponding period. For such multiple TRS bursts, the time lags of the multiple TRS bursts may be iPN_{OFDM}T_{OFDM}+j, ∀j∈{0, 4T_{OFDM}, N_{OFDM}T_{OFDM} and (N_{OFDM}+4) T_{OFDM}} for each i^{th} TRS burst, in which P is the number of slots separating two consecutive TRS bursts. Thus, the use of the TRS burst 202 and the TRS burst 204 may shorten the time lag between repeating of TRS bursts.

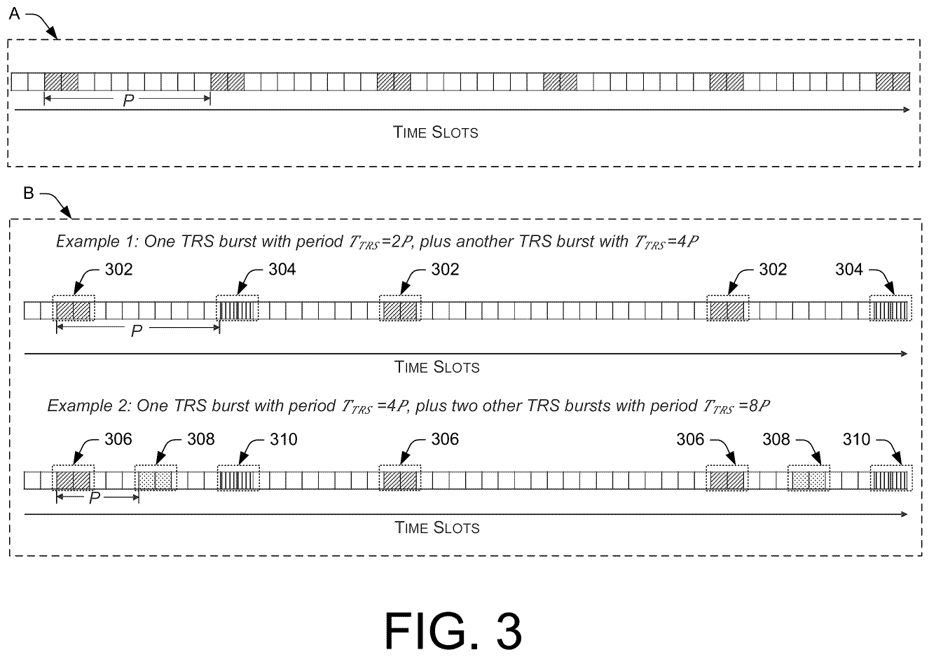

As shown in FIG. 3 multiple TRS bursts may be configured by the network node 125 using several methods. These methods assume the use of a two-slot TRS configuration for each TRS burst. Part A of FIG. 3 shows an implementation in which one periodic TRS burst is used, in which the period T_{TRS} of the TRS burst is T_{TRS}=P. Part B of FIG. 3 shows the use of multiple periodic TRS bursts, in which one TRS burst may have a smaller periodicity for regular time-frequency tracking, and one or more additional TRS bursts are configured for TDCP calculation with one or more larger periodicities. Example 1 shown in Part B is for a configuration in which a first TRS burst 302 has a period T_{TRS}=2P, and a second TRS burst 304 has a period of T_{TRS}=4P. In this example, the offset between the TRS bursts may be P, and the TDCP calculation may be performed every 4P to save resources and reduce overhead. Example 2 shown in Part B is for a configuration in which a first TRS burst 306 has a period T_{TRS}=4P, and two other TRS bursts, 308 and 310, respectively have a period T_{TRS}=8P. In this example, the offset between the TRS bursts may be P and 2P. In other implementations, the use of one or more periodic TRS bursts as shown in FIG. 3, in which at least one periodic TRS burst is used for regular time-frequency tracking, may be further combined with the use of one or more semi-persistent or aperiodic TRS bursts.

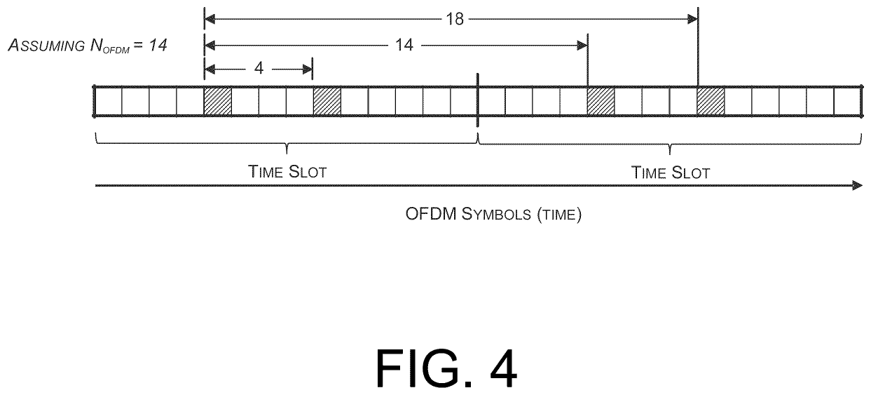

Since P is the separation between two TRS bursts used for TDCP calculation, P may dictate the time lags for AC calculation, i.e., iPN_{OFDM}+j, ∀j∈E {0, 4T_{OFDM}, N_{OFDM}T_{OFDM} and (N_{OFDM}+4) T_{OFDM}}. Further, OFDM symbols carrying TRS (for one TRS burst) are not uniformly spaced. For instance, the example spacing of CSIRS resources in the OFDM symbols of two time slots may be depicted as shown in FIG. 4, assuming the number of OFDM symbols per time slot is 14. Accordingly, multiple requirements on time lags for TDCP calculation may exist for the network node 125. For example, when configuring TRS bursts, the network node 125 may need to adhere to a minimum and a maximum lag value or a minimum number of lags at which AC is calculated. In some implementations, rather than having two CSIRS resources per time slot as shown in FIG. 4, the network node 125 may configure each time slot to carry only one CSIRS resource to save overhead.

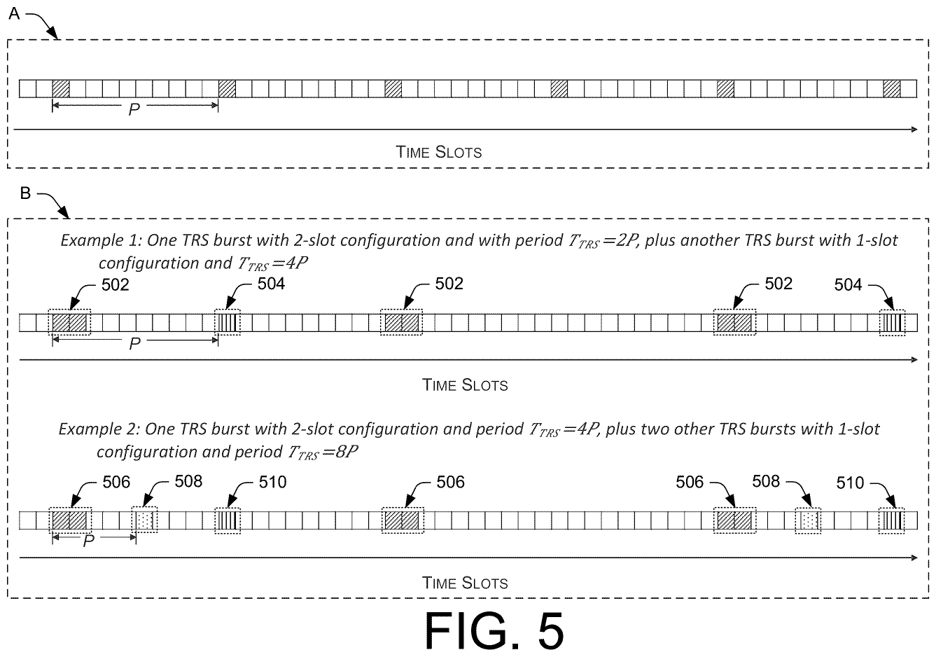

FIG. 5 shows example implementations of TRS bursts by the network node 125 that uses one-slot TRS configurations alternatively or in combination with two-slot TRS configurations. A one-slot TRS configuration in a configuration in which there is a single CSIRS resource-containing time slot per corresponding period. The use of one-slot TRS configurations, as opposed to the sole use of two-slot TRS configurations for implementing TRS bursts depicted in FIG. 3, may save resource overhead. Part A of FIG. 5 shows an implementation in which one periodic TRS burst with a one-slot TRS configuration is used, in which the period T_{TRS} of the TRS burst is T_{TRS}=P. Part B of FIG. 5 shows the use of multiple periodic TRS bursts, in which one TRS burst may have a smaller periodicity for regular time-frequency tracking, and one or more additional TRS bursts are configured for TDCP calculation with one or more larger periodicities. Example 1 shown in Part B is for a configuration in which a first TRS burst 502 with a two slot-configuration has a period T_{TRS}=2P, and a second TRS burst 504 with a one-slot configuration has a period of T_{TRS}=4P. In this example, the offset between the TRS bursts may be P, and the TDCP calculation may be performed every 4P to save resources and reduce overhead. Example 2 shown in Part B is for a configuration in which a first TRS burst 506 with a two-slot configuration has a period T_{TRS}=4P, and two other TRS bursts, 508 and 510 with a one-slot configuration, respectively has a period T_{TRS}=8P. In this example, the offset between the TRS bursts may be P and 2P. The use of two-slot TRS configurations in the various examples of FIG. 5 in combination with the one-slot TRS configurations may aid in synchronization. In other implementations, the use of one or more periodic TRS bursts as shown in FIG. 5, in which at least one periodic TRS burst is used for regular time-frequency tracking, may be further combined with the use of one or more semi-persistent or aperiodic TRS bursts.

In some implementations, a particular collection of multiple TRS resource sets may be defined by the network node 125 as a TRS group. Accordingly, a single downlink control information (DCI) triggering event and/or a medium access control (MAC) Control Element (CE) may be used by the network node 125 to activate all TRS bursts within a group. In some implementations, the network node 125 may define a general structure for TRS in order to provide greater flexibility, in which the general structure enables the setting of generic configurable values for: (1) CSIRS resources per time slot, (2) number of slots per period, and (3) variable time slot separation, i.e., variable amount of time separation between time slots that is suitable for a wide range of TRS-based parameters, including TDCP. The current legacy TRS design may be designated as a special case of such a general structure. The trsInfo flag for the associated CSIRS resource sets in such a general structure may be set to enabled. Accordingly, the general structure may be used in conjunction with legacy TRS to calculate various CSI parameters (e.g., TDCP).

In addition to the TRS-based TDCP, more general CSIRS resource sets may also be used for TDCP calculations in other implementations. Accordingly, the trsInfo flag for the associated CSIRS resource set may be disabled. In this way, CSIRS resources based on row 0 in Table 7.4.1.5.3-1 of 3GPP TS 38.211 and/or other rows in the table may be used for TDCP calculation.

In other implementations, TRS with different time-domain behaviors (e.g., periodic, aperiodic) may be jointly configured and used for calculating and reporting various CSI parameters that include and are in addition to TDCP. Furthermore, TRS with two-slot and one-slot configurations may also be used to calculate and report various CSI parameters that include and are in addition to TDCP.

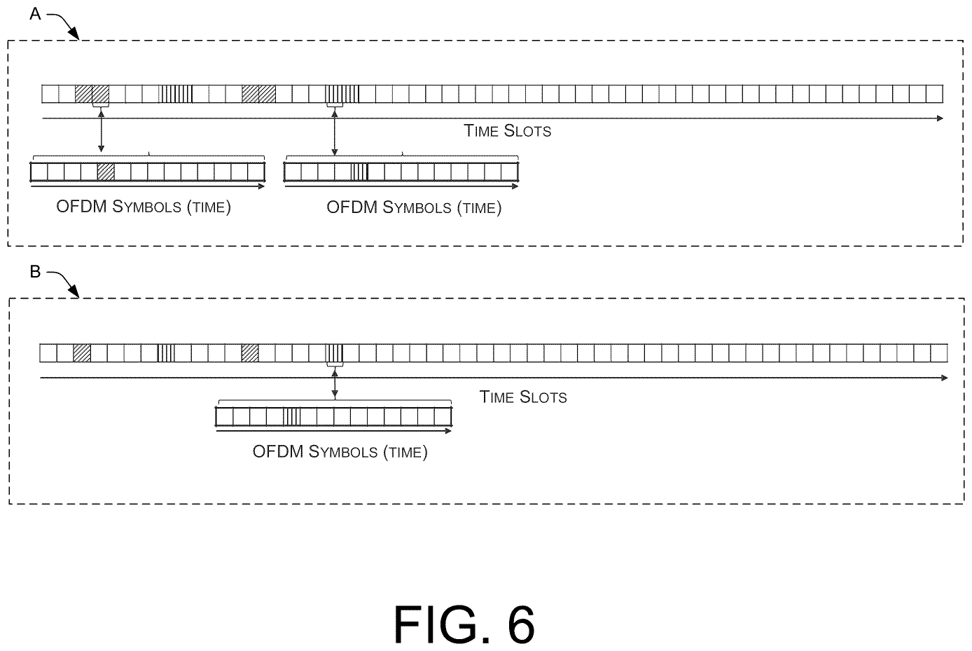

FIG. 6-11 further illustrate various TRS configurations in additional detail. As shown in Part A of FIG. 6, multiple TRS bursts may be configured in which there are two adjacent time slots that contain CSIRS resources per respective period, but only one CSIRS resource in each time slot, i.e., only one of the OFDM symbols in each time slot carries a CSIRS resource.

As shown in Part B of FIG. 6, multiple TRS bursts may be configured in which there is only one time slot that contains CSIRS resource per respective period, and there is only one CSIRS resource in each time slot, i.e., only one of the OFDM symbols in each time slot carries a CSIRS resource.

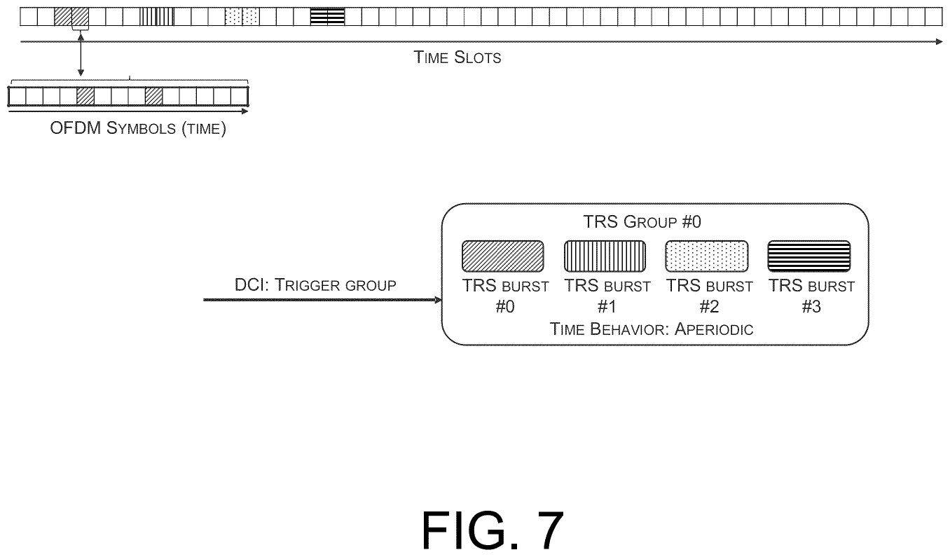

As shown in FIG. 7, a TRS group may be defined that includes multiple TRS bursts, e.g., TRS bursts #0, #1, #2, and #3. In this way, a single DCI triggering event and/or a MAC CE may be used to activate all of the multiple TRS bursts. In some instances, the multiple TRS bursts may be periodic such that they repeat after being triggered. However, in other instances, the multiple TRS bursts may be semi-persistent or aperiodic, such that they occur only once after being dynamically triggered. In such instances, multiple DI triggering events and/or MAC CEs may be used to repeatedly and dynamically trigger the multiple TRS bursts.

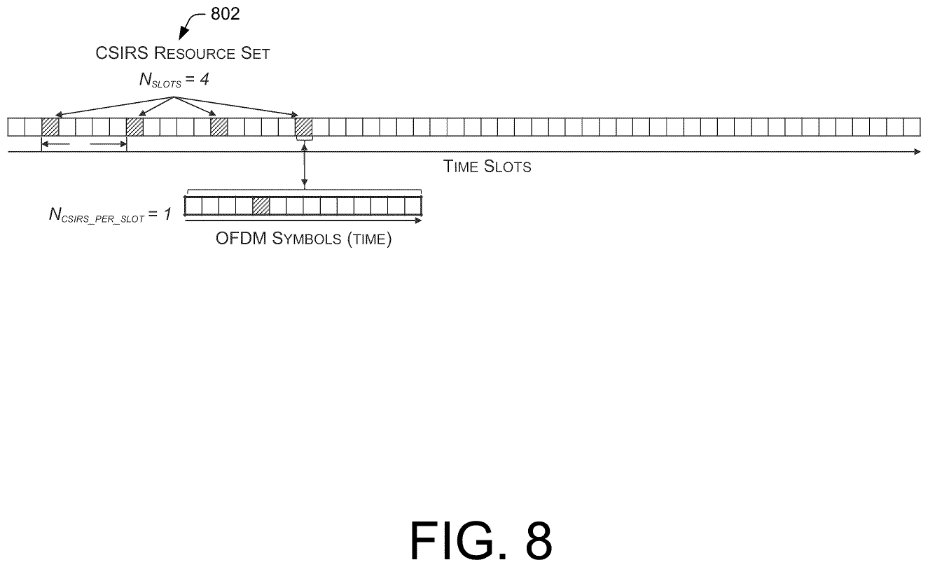

FIG. 8 illustrates the various TRS configuration parameters that may be applied in a TRS configuration. As shown, the CSIRS resources in a TRS resource set 802, i.e., TRS burst, occupy multiple time slots that are denoted by Nₛₗₒₜₛ, in which the number of CSIRS resources per time slot is given by

$${N}_{{CSIRS}_{{per}_{slot}}} .$$

The total number of CSIRS resources per the TRS burst is given by:

$${N}_{slots} \times {N}_{{CSIRS}_{{per}_{slot}}} ,$$

and the time slots carrying TRS are evenly spaced with a period given by: by S_{TRS}. The TRS burst can be periodic, aperiodic, or semi-persistent. Thus, uniformly sampled auto-correlation (AC) coefficients may be calculated in some configurations with no wasted resources. For instance, in the example shown in FIG. 8, four CSIRS resources are placed uniformly across multiple time slots. This enables the calculation of an auto-correlation function with uniformly spaced coefficients that is more convenient for TDCP.

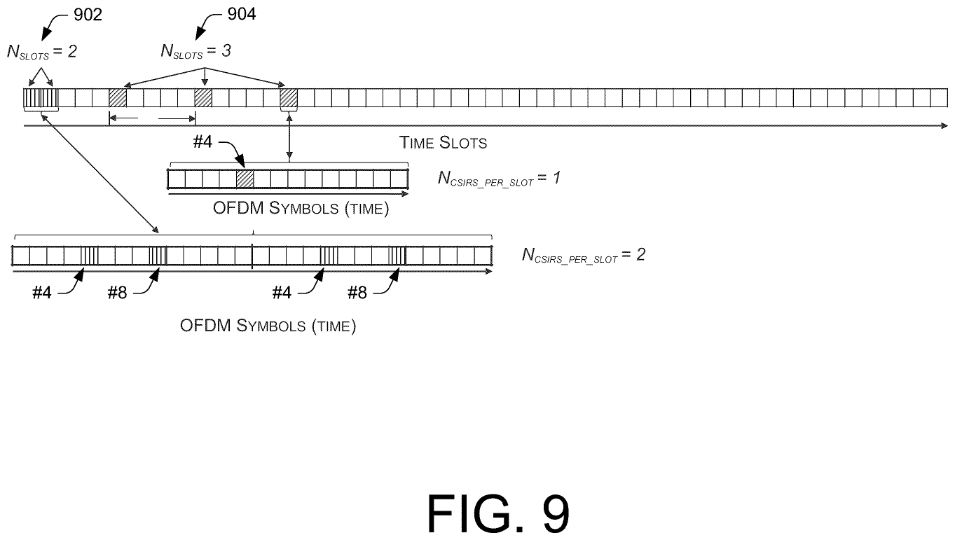

FIG. 9 illustrates a first combination of an example legacy TRS configuration with an example new TRS configuration in accordance with the present disclosure. As shown, the example legacy TRS burst 902 has a two-slot structure, with CSIRS resources in OFDM symbols #4 and #8. The example new TRS burst 904 occupies three different time slots, with CSIRS resource in OFDM symbol #4 in all the occupied time slots, in which the time slots carrying TRS are evenly spaced with a period given by S_{TRS}. Thus, because the network node 125 configured an initial offset between the TRS burst 902 and TRS burst 904 that is equivalent to the periodS_{TRS}, the time lag between the TRS bursts 902 and 904 are the same. Accordingly, the TRS bursts 902 and 904 may be used simultaneously to construct the auto-correlation sequence.

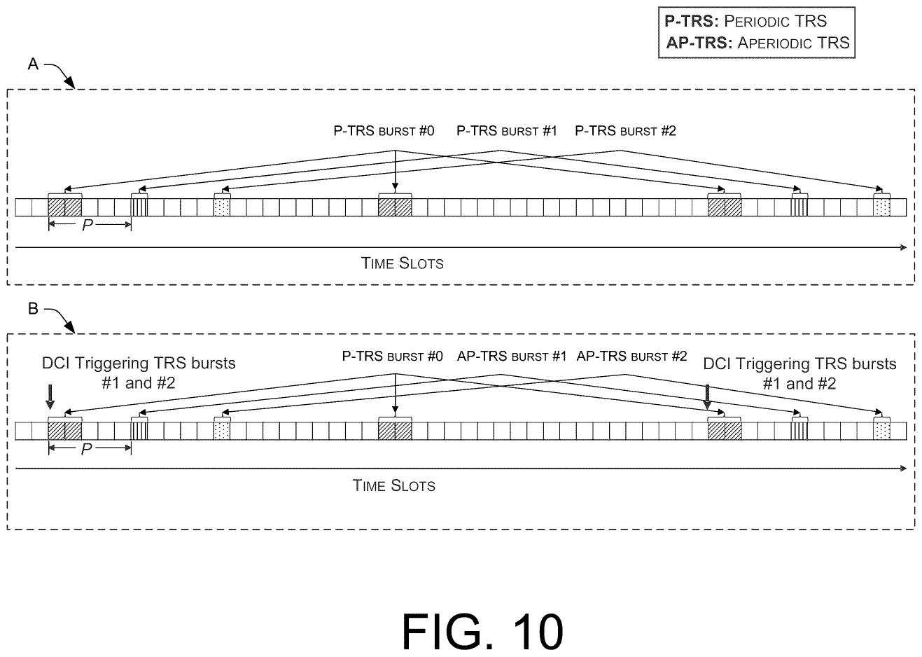

FIG. 10 illustrates a second combination of an example legacy TRS configuration with an example new TRS configuration in accordance with the present disclosure. In FIG. 10, the example legacy TRS burst #0 has a two-slot structure, while an example new TRS burst #1 and an example new TRS #2 each have a one-slot structure. As shown in Part A of FIG. 10, all of the TRS bursts #0, #1, and #2 may be periodic, such that all of the TRS bursts repeat at regular intervals. However, as shown in Part B of FIG. 10, the TRS burst #0 may be periodic while the TRS bursts #1 and #2 are aperiodic and have to be activated by a DCI triggering event and/or by a MAC CE. Such TRS bursts with different time-domain behavior may be used for the calculation of various CSI parameters that include TDCP.

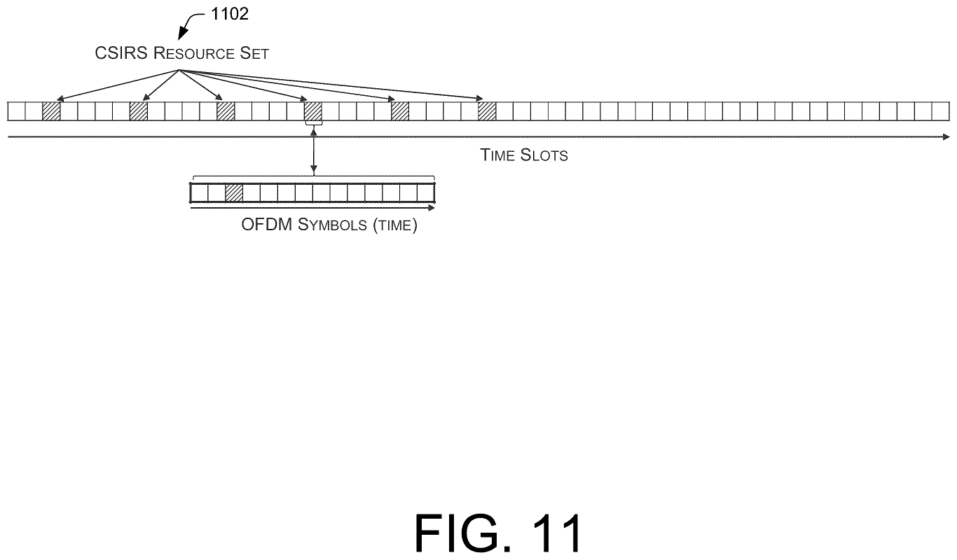

FIG. 11 illustrates an example configuration of non-TRS CSIRS resources by the network node 125 for the calculation of TCDP by a UE, such as the UE 110. The network node 125 may configure multiple non-zero power (NZP) CSIRS resources and group them into a CSIRS resource set for the purpose of TDCP calculation. In the example shown in FIG. 11, the configured CSIRS resource set 1102 may include six CSIRS resources in six time slots that are uniformly spaced, in which only one of the OFDM symbols in each time slot carries a CSIRS resource. Nevertheless, in various implementations, the CSIRS resources may be periodic or aperiodic, and the CSIRS may be uniformly spaced or non-uniformly spaced.

### Illustrative Implementations

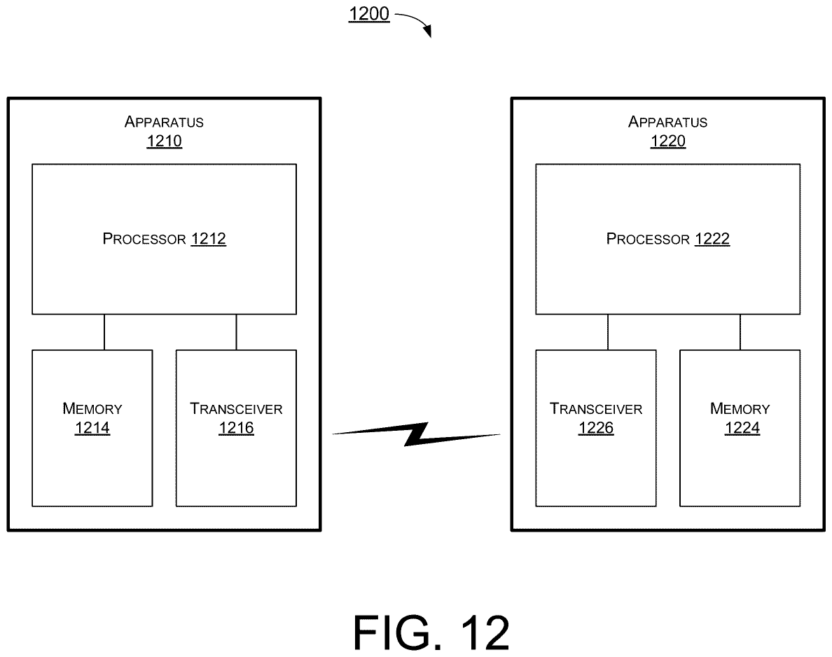

FIG. 12 illustrates an example communication system 1200 having at least an example apparatus 1210 and an example apparatus 1220 in accordance with an implementation of the present disclosure. Each of apparatus 1210 and apparatus 1220 may perform various functions to implement schemes, techniques, processes and methods described herein pertaining to improved reference signal configuration for time-domain channel property evaluation, including the various schemes described above with respect to various proposed designs, techniques, concepts, schemes, systems and methods described above, including network environment 100, as well as processes described below.

Each of apparatus 1210 and apparatus 1220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1210 and apparatus 1220 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 1210 and apparatus 1220 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 1210 and apparatus 1220 may be implemented in a smart thermostat, a smart fridge, a smart door lock, a wireless speaker or a home control center. When implemented in or as a network apparatus, apparatus 1210 and/or apparatus 1220 may be implemented in an eNodeB in an LTE, LTE-Advanced or LTE-Advanced Pro network or in a gNB or TRP in a 5G network, an NR network or an IoT network.

In some implementations, each of apparatus 1210 and apparatus 1220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1210 and apparatus 1220 may be implemented in or as a network apparatus or a UE. Each of apparatus 1210 and apparatus 1220 may include at least some of those components shown in FIG. 12 such as a processor 1212 and a processor 1222, respectively, for example. Each of apparatus 1210 and apparatus 1220 may further include one or more other components not pertinent to the proposed scheme of the present disclosure (e.g., internal power supply, display device and/or user interface device), and, thus, such component(s) of apparatus 1210 and apparatus 1220 are neither shown in FIG. 12 nor described below in the interest of simplicity and brevity.

In one aspect, each of processor 1212 and processor 1222 may be implemented in the form of one or more single-core processors, one or more multi-core processors, or one or more CISC or RISC processors. That is, even though a singular term “a processor” is used herein to refer to processor 1212 and processor 1222, each of processor 1212 and processor 1222 may include multiple processors in some implementations and a single processor in other implementations in accordance with the present disclosure. In another aspect, each of processor 1212 and processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1212 and processor 1222 is a special-purpose machine specifically designed, arranged and configured to perform specific tasks including those pertaining to CSI pre-processing in accordance with various implementations of the present disclosure.

In some implementations, apparatus 1210 may also include a transceiver 1216 coupled to processor 1212. Transceiver 1216 may be capable of wirelessly transmitting and receiving data. In some implementations, transceiver 1216 may be capable of wirelessly communicating with different types of wireless networks of different radio access technologies (RATs). In some implementations, transceiver 1216 may be equipped with a plurality of antenna ports (not shown) such as, for example, four antenna ports. That is, transceiver 1216 may be equipped with multiple transmit antennas and multiple receive antennas for multiple-input multiple-output (MIMO) wireless communications. In some implementations, apparatus 1220 may also include a transceiver 1226 coupled to processor 1222. Transceiver 1226 may include a transceiver capable of wirelessly transmitting and receiving data. In some implementations, transceiver 1226 may be capable of wirelessly communicating with different types of UEs/wireless networks of different RATs. In some implementations, transceiver 1226 may be equipped with a plurality of antenna ports (not shown) such as, for example, four antenna ports. That is, transceiver 1226 may be equipped with multiple transmit antennas and multiple receive antennas for MIMO wireless communications.

In some implementations, apparatus 1210 may further include a memory 1214 coupled to processor 1212 and capable of being accessed by processor 1212 and storing data therein. In some implementations, apparatus 1220 may further include a memory 1224 coupled to processor 422 and capable of being accessed by processor 1222 and storing data therein. Each of memory 1214 and memory 1224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1214 and memory 1224 may include a type of read-only memory (ROM) such as mask ROM, programmable ROM (PROM), erasable programmable ROM (EPROM) and/or electrically erasable programmable ROM (EEPROM). Alternatively, or additionally, each of memory 1214 and memory 1224 may include a type of non-volatile random-access memory (NVRAM) such as flash memory, solid-state memory, ferroelectric RAM (FeRAM), magnetoresistive RAM (MRAM) and/or phase-change memory.

Each of apparatus 1210 and apparatus 1220 may be a communication entity capable of communicating with each other using various proposed schemes in accordance with the present disclosure. For illustrative purposes and without limitation, a description of capabilities of apparatus 1210, as a UE (e.g., UE 110), and apparatus 1220, as a network node (e.g., network node 125) of a network (e.g., network 130 as a 5G/NR mobile network), is provided below in the context of example processes 1300-1500.

### Illustrative Processes

Each of the processes 1300-1500 may represent an aspect of implementing various proposed designs, concepts, schemes, systems and methods described above, whether partially or entirely, including those pertaining to those described above. Each process may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Each process may be implemented by or in apparatus 1210 and/or apparatus 1220 as well as any variations thereof. Solely for illustrative purposes and without limiting the scope, each process is described below in the context of apparatus 1210 as a UE (e.g., UE 110) and apparatus 1220 as a communication entity such as a network node or base station (e.g., terrestrial network node 125 or non-terrestrial network node 128) of a network (e.g., network 130 as a 5G/NR mobile network).

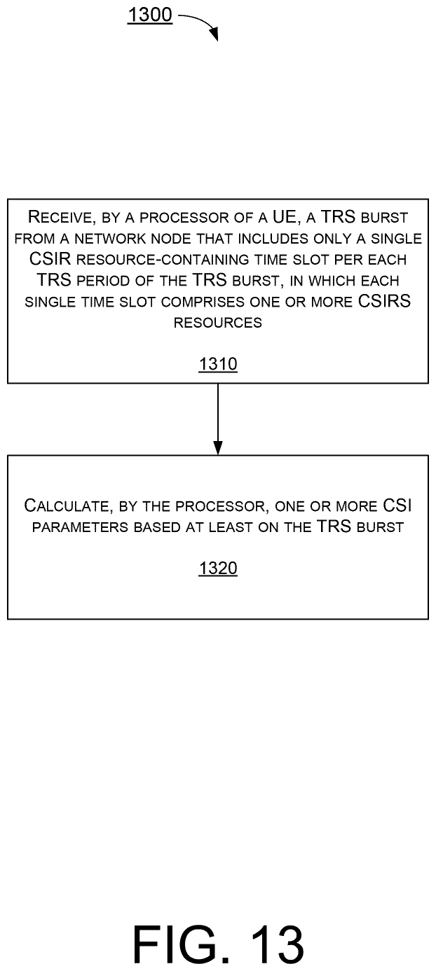

FIG. 13 illustrates an example process 1300 in accordance with an implementation of the present disclosure. Process 1300 may begin at block 1310. At 1310, process 1300 may include processor 1212 of apparatus 1210 receiving a TRS burst from a network node that includes only a single CSIRS resource-containing time slot per each TRS period of the TRS burst, in which each single time slot comprises one or more CSIRS resources. In some implementations, the TRS burst may be in FR1 that includes frequency bands of sub-6 GHz frequencies. Process 1300 may proceed from 1310 to 1320.

At 1320, process 1300 may include processor 1212 calculating one or more channel state information (CSI) parameters based at least on the TRS burst. In some instances, each single CSIRS resource-containing time slot may include only one CSIRS resource. In some implementations, in performing the calculating, process 1300 may include processor 1212 calculating a TDCP. In some instances, the TRS burst may be a periodic TRS burst, an aperiodic TRS burst, or a semi-persistent TRS burst.

In some implementations, the process 1300 may further include processor 1212 receiving an additional TRS burst in FR1 from the network node that includes one or more CSIRS resource-containing time slots per each TRS period of the additional TRS burst, wherein the each of the one or more CSIRS resource-containing time slots includes one or more CSIRS resources.

In some instances of such implementations, each of the one or more CSIRS resource-containing slots of the additional TRS burst may include only a single CSIRS resource or multiple CSIRS resources. In some instances of such implementations, in performing the calculating, process 1300 may include processor 1212 calculating the one or more CSI parameters based at least on the TRS burst and the additional TRS burst. In some instances of such implementations, the TRS burst may be an aperiodic TRS burst while the additional TRS burst is a periodic burst, or the TRS burst may be a periodic TRS burst when the additional TRS burst is an aperiodic TRS burst.

In some implementations, the one or more CSI parameters may include one or more TDCPs that are used by the network node to determine an optimal codebook or determine an SRS periodicity. In some implementations, the one or more CSI parameters may include multiple TDCPs that provide auto-correlation coefficients used by the network node to calculate either or both of a doppler spectrum and a delay spread.

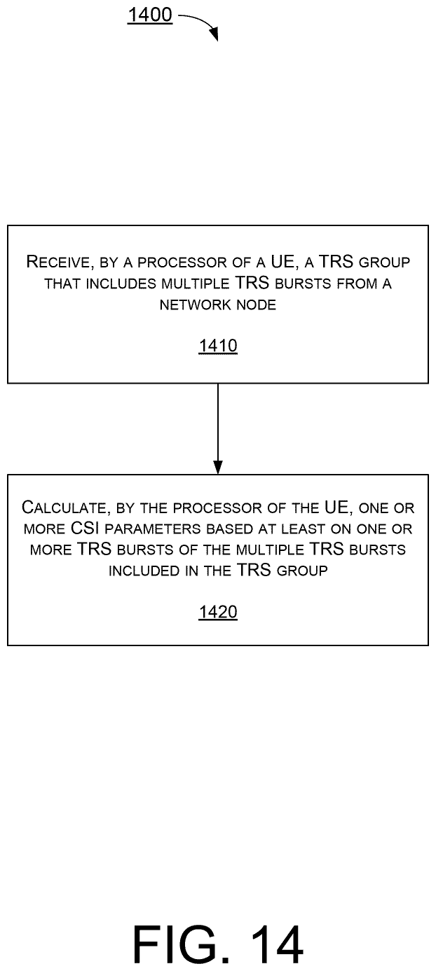

FIG. 14 illustrates an example process 1400 in accordance with an implementation of the present disclosure. Process 1400 may begin at block 1410. At 1410, process 1400 may include processor 1212 of apparatus 1210 receiving a TRS group that includes multiple TRS bursts from a network node. Process 1400 may proceed from 1410 to 1420.

At 1420, process 1400 may include processor 1212 calculating one or more CSI parameters based at least on one or more TRS bursts of the multiple TRS bursts included in the TRS group. In some instances, each of the multiple TRS bursts may include a predetermined number of CSIRS resource-containing time slots per each corresponding TRS period of each TRS burst. In some instances, each of the CSIRS resource-containing time slots may include a predetermined number of CISRS resources. In some instances, the CSIRS resource-containing time slots of a first TRS burst and a second TRS burst of the multiple TRS bursts may be separated by a predetermined separation time slot interval.

In some implementations, the network node may be triggered to provide the TRS group to the UE by a DCI triggering event and/or by a MAC CE. In some implementations, process 1300 may further include processor 1212 receiving an additional TRS burst in conjunction with the TRS group, such that the calculating by the processor 1212 includes calculating the one or more CSI parameters based on the TRS group and the additional TRS burst, wherein the one or more CSI parameters may include a TDCP.

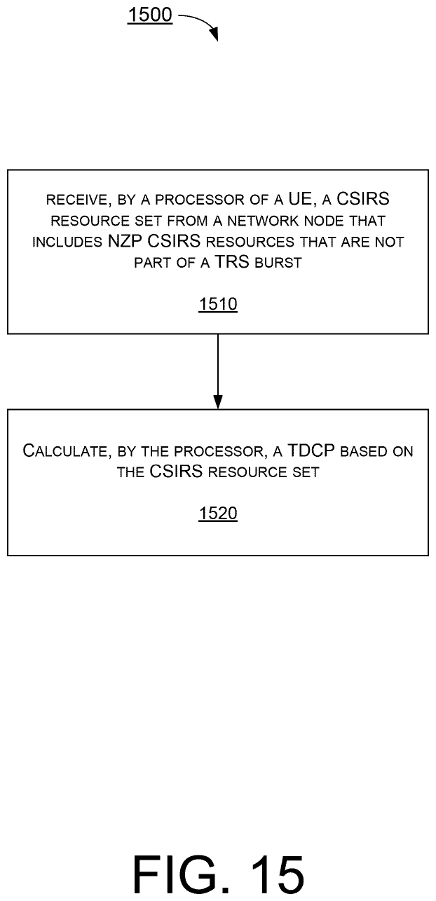

FIG. 15 illustrates an example process 1500 in accordance with an implementation of the present disclosure. Process 1500 may begin at block 1510. At 1510, process 1500 may include processor 1212 of apparatus 1210 receiving a CSIRS resource set that includes multiple NZP CSIRS resources that are not part of a TRS burst. Process 1500 may proceed from 1510 to 1520.

At 1520, process 1500 may include processor 1212 calculating a TDCP based on the CSIRS resource set. In some implementations, the multiple NZP CSIRS resources may be periodic CSIRS resources or aperiodic CSIRS resources that are triggered by one or more DCI triggering events and/or by one or more MAC CEs. In some implementations, the multiple NZP CSIRS resources may be uniformly spaced or non-uniformly spaced across a plurality of time slots.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a tracking reference signal (TRS) burst from a network node that includes only a single channel state information reference signal (CSIRS) resource-containing time slot per each TRS period of the TRS burst, in which each single CSIRS resource-containing time slot comprises one or more CSIRS resources; and
calculating, by the processor of the UE, one or more channel state information (CSI) parameters based at least on the TRS burst.

2. The method of claim 1, wherein each single CSIRS resource-containing time slot includes only one CSIRS resource.

3. The method of claim 1, wherein calculating the one or more CSI parameters includes calculating a time-domain channel property (TDCP).

4. The method of claim 1, wherein the TRS burst is a periodic TRS burst, an aperiodic TRS burst, or a semi-persistent TRS burst.

5. The method of claim 1, further comprising:
receiving, by the processor of the UE, an additional TRS burst in FR1 from the network node that includes one or more CSIRS resource-containing time slots per each TRS period of the additional TRS burst,
wherein the each of the one or more CSIRS resource-containing time slots includes one or more CSIRS resources.

6. The method of claim 5, wherein each of the one or more CSIRS resource-containing slots of the additional TRS burst includes only a single CSIRS resource or multiple CSIRS resources.

7. The method of claim 5, wherein the calculating includes calculating the one or more CSI parameters based at least on the TRS burst and the additional TRS burst.

8. The method of claim 5, wherein the TRS burst is an aperiodic TRS burst and the additional TRS burst is a periodic TRS burst, or the TRS burst is a periodic TRS burst and the additional TRS burst is an aperiodic TRS burst.

9. The method of claim 1, wherein the one or more CSI parameters include one or more time-domain channel properties (TDCPs) that are used by the network node to determine an optimal codebook or determine a sounding reference signal (SRS) periodicity.

10. The method of claim 1, wherein the one or more CSI parameters include multiple time-domain channel properties (TDCPs) that provide auto-correlation coefficients used by the network node to calculate either or both of a doppler spectrum and a delay spread.

11. The method of claim 1, wherein the in TRS burst is in Frequency Range 1 (FR1), and wherein the FR1 includes frequency bands of sub-6 GHz frequencies.

12. A method, comprising:
receiving, by a processor of a user equipment (UE), a tracking reference signal (TRS) group that includes multiple TRS bursts from a network node; and
calculating, by the processor of the UE, one or more channel state information (CSI) parameters based at least on one or more TRS bursts of the multiple TRS bursts included in the TRS group.

13. The method of claim 12, wherein the network node is triggered to provide the TRS group to the UE by either or both of a downlink control information (DCI) triggering event and a medium access control (MAC) Control Element (CE).

14. The method of claim 12, wherein each of the multiple TRS bursts includes a predetermined number of channel state information reference signal (CSIRS) resource-containing time slots per each corresponding TRS period of each TRS burst.

15. The method of claim 14, wherein each of the CSIRS resource-containing time slots includes a predetermined number of CISRS resources.

16. The method of claim 14, wherein the CSIRS resource-containing time slots of a first TRS burst and a second TRS burst of the multiple TRS bursts are separated by a predetermined separation time slot interval.

17. The method of claim 12, further comprising receiving, by the processor of the UE, an additional TRS burst in conjunction with the TRS group, wherein the calculating includes calculating the one or more CSI parameters based on the TRS group and the additional TRS burst, wherein the one or more CSI parameters includes a time-domain channel property (TDCP).

18. An apparatus, comprising:
a transceiver configured to communicate wirelessly; and
a processor coupled to the transceiver and configured to
receive, from a network node, a channel state information reference signal (CSIRS) resource set that includes multiple non-zero power (NZP) CSIRS resources that are not part of a TRS burst; and
calculate a time-domain channel property (TDCP) based on the CSIRS resource set.

19. The apparatus of claim 18, wherein the multiple NZP CSIRS resources are periodic CSIRS resources or aperiodic CSIRS resources that are triggered by one or more downlink control information (DCI) triggering events.

20. The apparatus of claim 18, wherein the multiple NZP CSIRS resources are uniformly spaced or non-uniformly spaced across a plurality of time slots.
